(19) United States
(12) Patent Application Publication
(10) Pub. No.: US 2013/0125181 A1
(43) Pub. Date: May 16, 2013

(54) Dynamic Video Platform Technology

(71) Applicants: Eduardo Montemayor, Chicago, IL (US); Kirk Wagner Davis, Park Ridge, IL (US); Jessica Cather, Park Forest, IL (US)

(72) Inventors: Eduardo Montemayor, Chicago, IL (US); Kirk Wagner Davis, Park Ridge, IL (US); Jessica Cather, Park Forest, IL (US)

(73) Assignee: LIQUIDUS MARKETING, INC., Chicago, IL (US)

(21) Appl. No.: 13/475,576

(22) Filed: May 18, 2012

Related U.S. Application Data
(60) Provisional application No. 61/559,957, filed on Nov. 15, 2011.

(51) Int. Cl. H04N 21/20

(52) U.S. Cl. 725/93

(57) ABSTRACT

Some embodiments provide one or more portions of a video production system that can generate a dynamic data-driven video presentation using video configuration information based on information about a user, a user device, and/or a particular video presentation. In some cases a method includes receiving a request for a dynamic data-driven video presentation from a user device, determining video identification and user device information from the request, generating corresponding video configuration information and sending the video configuration information to the user device for generating the video presentation. In some cases a system is provided including processing circuitry configured to implement one or more of the foregoing processes. In additional cases, a method for generating a video presentation includes requesting a dynamic data-driven video presentation, receiving video configuration information, requesting and receiving video assets, and assembling the video assets to generate and display a video presentation.

### CROSS-REFERENCES

This application claims the benefit of U.S. Provisional Application No. 61/559,957, filed Nov. 15, 2011, the content of which is hereby incorporated by reference in its entirety.

### FIELD

The following disclosure generally relates to the generation of video presentations for promoting products and services, and more specifically relates to request-driven video presentations.

### BACKGROUND

Many companies produce “data-driven videos” for presenting goods and services online to consumers. Data-driven video allows automating the production of video presentations from a set of product/services data to make production of large quantities of videos possible. This product data is made available for video production through data feeds or via access to application programming interfaces (APIs). A video production system can ingest data (for any given product) that includes fields of information about that product, along with URLs that link to various assets associated with the product, such as photos, images, video clips, text files, sound clips, etc. The system will assemble the assets into a “slideshow” that may include, for example, a combination of images, photos, video/sound clips, descriptive graphic overlays and/or narrative audio files (e.g., voiceovers) that accompany a visual presentation.

Once a data-driven video slideshow is assembled, the traditional next step is to convert or “encode” the video into a specified “hard file” or “flat file” format, such as MPEG, .flv, .wmv, .mp4, 4MV, or related format so that it may be distributed online and be enabled to play in traditional media players. By their nature, such videos are “non-dynamic” once saved in these static formats (unlike “dynamic” real-time video presentations). Working with video hard files presents a number of serious limitations from a production, distribution and cost standpoint. As just a few examples, it is necessary to pre-generate, host and serve these files, which can be costly in terms of turnaround time, bandwidth, and hosting.

In addition, if a video needs to be updated or edited, the hard file must be removed from online distribution points, discarded, reproduced and redeployed online, which necessarily involves greater costs and turnaround times, while also raising accuracy issues. For example, because hard files are often out-of-date compared to the most recent revisions to the data about that product—whether that data relates to pricing, specs, availability, etc.

Another limitation relates to the format of a hard file. For example, if a hard file with a particular format needs to be viewed on platforms that do not support the particular format, another hard file format needs to be generated. One example includes the incompatibility of Flash video (.flv—generated with the Adobe® Flash® platform) with iOS platforms (e.g., used with iPads® and iPhones® developed by Apple Inc.), for which another hard file format needs to be generated (.mp4 or .4MV) so the video may be viewed on these devices that do not support .flv formats. This requires more production and invokes the bandwidth, hosting and other requirements cited above to enable playback on iOS platforms. Moreover, hard-file downloading is extremely slow on mobile connections where expensive streaming capabilities are not in use.

Further, the playback of hard files cannot be configured or changed to display or play in a customized manner on any of these or other devices (such as devices running the Android operating system, PCs and Macintosh computers). Control of the user experience is limited because these hard files are in a fixed, static standardized format that play a particular way in a particular media player on a particular device—a “one-size-fits-all” scenario.

In addition, hard files do not lend themselves to types of user experience management that allow for the customization and adaptation of a video presentation based on what a customer does when viewing the website content. These limitations in customization and adaptation mirror limitations in logging and reporting capabilities with hard files because information about what is happening within a video session cannot be identified, logged or reported.

### SUMMARY

Some embodiments described herein generally relate to dynamic request-driven or data-driven video presentations that are generated upon a request from an operator of a user device. In some embodiments a method is provided that includes generating video configuration information. The method includes receiving, with processing circuitry, a request from a user device through a computer network to generate a dynamic data-driven video presentation using one or more video assets. The request includes video identification information and user device information. The method further includes determining, with the processing circuitry, the video identification information and the user device information from the request, and then generating, with the processing circuitry, video configuration information based on the video identification information and the user device information. The method further includes sending the video configuration information to the user device through the computer network. The user device can then use the video configuration information to generate the video presentation.

In some embodiments a system is provided that includes processing circuitry configured to implement steps in a process of generating video configuration information. For example, in some cases the processing circuitry is configured to receive a request from a user device through a computer network to generate a dynamic data-driven video presentation using one or more video assets. The processing circuitry is configured to determine video identification information and user device information describing the user device from the request. In addition, the processing circuitry is configured to generate video configuration information based on the video identification information and the user device information and then send the video configuration information to the user device through the computer network to enable the user device to generate the video presentation based on the video configuration information.

In some embodiments, a method for generating a dynamic, data-driven video presentation with a user device is provided. The method includes sending, with the user device (which includes processing circuitry and an electronic display) a request through a computer network to generate a video presentation using one or more video assets stored in a computer readable storage medium separate from the user device. The request at least includes video identification information and user device information describing the user device. The method further includes receiving, with the user device, video configuration information generated based on the video identification information and the user device information and then receiving, with the user device, the one or more video assets. After receiving the video assets, the method includes generating, with the user device, the video presentation based on the video configuration information and displaying the video presentation on the electronic display of the user device.

Some embodiments enable the scalable creation and generation of customized, dynamic online product and services video presentations from a set of product and services data (sometimes referred to herein as “video assets”), as well as user device data, activity data, and/or preferences data.

Some embodiments may optionally provide none, some, or all of the following advantages, though other advantages not listed here may also be provided. In some cases video file hosting can be eliminated. In some cases the process of video editing can be eliminated because video can be instantly updated when refreshes to product and user data are received. In some cases video playback without hard files on mobile iOS and Android 2.2+ devices can be enabled. In some cases a video player can be optimized and configured as desired to maximize the video-viewing experience on devices such as mobile iOS devices, mobile Android 2.2+ device, PCs, and Macs without the playback and player-configuration limitations imposed by video hard files and associated players. In some cases video content can be adapted on-the-fly based on actions a user takes within a session. In some cases video content can be adapted on-the-fly based on actions a user takes across multiple sessions. In some cases user activity within these sessions can be logged and reported.

These and various other features, advantages, and/or implementations will be apparent from a reading of the following detailed description.

### BRIEF DESCRIPTION OF THE DRAWINGS

The following drawings are illustrative of particular embodiments of the present invention and therefore do not limit the scope of the invention. The drawings are not to scale (unless so stated) and are intended for use in conjunction with the explanations in the following detailed description. Some embodiments of the invention will hereinafter be described in conjunction with the appended drawings, wherein like numerals denote like elements.

FIG. 1 is a flow diagram illustrating a video generation process according to an embodiment.

FIG. 2A illustrates a collection of screenshots generated for a video presentation on a desktop computer according to an embodiment.

FIG. 2B is a depiction of a video presentation on a desktop computer according to an embodiment.

FIG. 3A illustrates a collection of screenshots generated for a video presentation on a smartphone according to an embodiment.

FIG. 3B is a depiction of a video presentation on a smartphone according to an embodiment.

FIG. 4 is a depiction of a video presentation with user-specific modifications according to an embodiment.

FIGS. 5-6 are depictions of a video segment displayed at different times within a video presentation according to some embodiments.

FIG. 7 is a schematic diagram illustrating a system according to an embodiment.

FIG. 8 is a flow diagram illustrating a method of generating a video presentation according to an embodiment.

FIG. 9 is a flow diagram illustrating a method of generating video configuration information according to an embodiment.

FIG. 10A is a schematic system diagram illustrating data flow between system components according to an embodiment.

FIG. 10B is a flow diagram illustrating a method of generating a video presentation using the system illustrated in FIG. 10A according to an embodiment.

### DETAILED DESCRIPTION OF THE PREFERRED EMBODIMENTS

The following detailed description is exemplary in nature and is not intended to limit the scope, applicability, or configuration of the invention in any way. Rather, the following description provides some practical illustrations for implementing some embodiments of the invention. Examples of hardware configurations, systems, processing circuitry, data types, programming methodologies and languages, communication protocols, and the like are provided for selected aspects of the described embodiments, and all other aspects employ that which is known to those of ordinary skill in the art. Those skilled in the art will recognize that many of the noted examples have a variety of suitable alternatives.

Multiple terms are used herein to describe various aspects of the embodiments. A selection of definitions for certain terms used herein is provided below. The terms should be understood in light of the definitions, unless further modified in the descriptions of the embodiments that follow.

Dynamic Data-Driven Video—A video presentation that is dynamically rendered with currently available data requested from a product/service database, in some cases with zero or minimal time delay. Subsequent renderings of a dynamic data-driven video presentation automatically change and/or update to reflect the current state of the data in the database as the data may be periodically changed or updated.

Video Assets—Components for creating a video slideshow. Some examples include, but are not limited to, data, information, text, images, photos, video clips, pre-rolls, post-rolls, and sound clips.

Graphic Overlays—Artistic renderings of text or images on the screen created from product information in a database. Some examples of graphic overlays could include information from a CARFAX® report, a certified purchase order, or any other relevant and/or desirable information. Some types of graphic overlays may have different sizes, include different content, and/or may provide an interactive (e.g., clickable) interface or a static interface.

Narrative Audio Files (Voiceovers)—Files such as data-driven Text-To-Speech files or “Concatenated Human Voice” files consisting of a variable series of pre-recorded audio files (e.g., .mp3 voiceovers) automatically selected based on a particular set of product data. A narrative audio file is one type of audio segment.

Pre-Roll or Post-Roll—A video clip or set of images that function as a promotion for an advertiser, either as an introduction prior to viewing specific product-related content or as a closing after viewing product-related content.

Video/Video Presentation/Slideshow/Video Slideshow—Terms used interchangeably herein to describe a dynamic, data-driven video presentation about a product or service that is generated and then displayed by a user device. The presentation can include any of a variety of components, including video assets, graphic overlays and/or voiceovers. Types of video assets may include data, information, text, images, images with camera transitions, photos, video clips, and sound clips

Video Production Platform (VPP)—A system or portion of a system that enables production of dynamic data-driven videos.

Liquidus DVP-4 (Liquidus Dynamic Video Platform-4)—One embodiment of a video production platform that provides a combination of technologies, including Real-Time Data-Driven Video with Platform Detection, Technology Detection, Device-Platform Adaptation, Session Management and Profile Management. Liquidus is a reference to Liquidus Marketing, Inc., and is used herein to describe offerings of Liquidus Marketing, Inc. according to some embodiments.

Platform Detection—The capability to detect information about a user device, such as the type of browser and type of device requesting video.

Technology Detection—The capability to determine technological components or hardware specifications of a user device, such as its processing speed, its bandwidth/connection speed, its screen size, etc.

Device-Platform Adaptation—The capability to configure and display a video player and video in a customized format for a particular device platform.

Session Management—The process of tracking and responding to the actions of a user in real-time during a session or site visit to adapt and render video as prompted by the user's behavior and preference indications during the session. In some circumstances a user session or visit is defined by the presence of a user with a specific IP (Internet Protocol) address who has not visited the site recently (e.g., anytime within the past 30 minutes—a user who visits a site at noon and then again at 3:30 pm would count as two user visits).

Profile Management—The process of logging and responding to a user's behavior based on the user's actions and preference indications over the course of multiple sessions to present the user with the most appropriate and relevant video content based on, e.g., the context of the current user and/or the device of the current user.

APIs—An abbreviation of application programming interface, an API is a set of routines, protocols, and tools for building software applications.

URL—Uniform Resource Locator: a protocol for specifying addresses on the Internet.

Hard Files (or Flat Files)—A variety of standardized media file formats (.flv, .wmv, .mp4, .4MV, etc.) that are pre-produced and are not related to, or do not contain any linkages to another file.

Media Player—A software application that controls audio and video of a computer or other user device.

iOS—A term used to describe Apple's mobile operating system, a licensed trademark of Cisco in the U.S. and other countries; developed originally for the iPhone®, it has since been shipped on the iPod Touch® and iPad® as well.

Android™—A trademark of Google, Inc., used to describe a mobile operating system developed by Google and based upon the Linux kernel and GNU software.

Encoding—The process, in video editing and production, of preparing the video for output, where the digital video is encoded to meet proper formats and specifications for recording and playback through the use of video encoder software.

Bandwidth—The data rate supported by a network connection or interface in a computer network and commonly expressed in terms of bits per second (bps).

Hosting—A service that runs Internet servers, allowing organizations and individuals to serve content to the Internet.

Playback Performance—As used herein, a variety of parameters including the size of the video player on a particular platform/screen, the video rendering speed, and/or the resolution.

Cookie—Also known as an HTTP cookie, web cookie, or browser cookie, a cookie is an indicator used by an origin website to send state information to a user's browser and for the browser to return the state information to the origin site for the purposes of authentication, identification of a user session, notification of a user's preferences, or other characteristics.

Logging—Recording of data passing through a particular point in a networked computer system.

As an introduction, some embodiments of the invention provide a dynamic video platform technology with a number of capabilities that are related to and/or can be used to enhance the core process of generating real time, dynamic data-driven videos (e.g., also described herein as “video presentations”). Use of the terms “data-driven” and/or “dynamic” indicate that the video presentation is generated with current product data, and that subsequently generated video presentations automatically change based on subsequent changes to the product data and/or user feedback being used to generate the video. Some embodiments provide the capability to generate dynamic data-driven video presentations based on a number of advantageous features and functionalities that will be described further herein. For example, some embodiments enable generation of video presentations based on platform/technology detection, session data, and profile data (user feedback) to further influence and customize the size, format, length, delivery and/or content of dynamic video presentations.

Dynamic data-driven video production heretofore has meant rendering and displaying video in real-time or near-real time directly from data about products and/or services. For example, when a user is on a website (e.g., GMCertified.com) and wishes to see a video of a vehicle listing (e.g., from Liquidus), the video is actually created in a matter of milliseconds, “on the fly,” when the user clicks on the video hyperlink. Clicking on the hyperlink starts a process of video generation that in one example requests data assets on the vehicle (text, images, video clips, etc.) from a database, assembles the images in their extant order in the data, incorporates camera effects (fades and/or zooms) and a music bed, displays graphic/text overlays based on the features data about the vehicle, and “stitches” together a series of pre-recorded .mp3 audio-narration files that correspond to the features for that vehicle. Some embodiments of the invention advantageously enable “dynamic rendering” of the video without necessitating the encoding conversion of the video presentation into a non-dynamic “hard file.” Thus, in some embodiments, video presentations do not actually exist until they are requested by a user. In other words, in some cases video presentations are not “pre-produced” (in contrast to a hard-file video). Instead, the video presentations are rendered with the current data in the database at the moment the user requests a video.

Some advantages of the instantaneous adaptability of this technology can be illustrated in the following example: if a price change occurs on a product (which can happen several times a day to a vehicle on a dealer's lot), that new data asset will be instantly entered and displayed when a user requests a new video rendering. No advertiser wants to wait days for a video to be re-edited and re-produced. Advertisers instead want that price change to be reflected in their listing video immediately after the modified information is entered in their product database. This is just one example; other examples, such as instant updates to product specifications, images, promotional messaging, and financing information, also illustrate the value of the instantaneous adaptability of some embodiments. Another advantage of this type of dynamic rendering is that it avoids waste of time and resources: no extraneous, unrequested, or unwanted video will be produced because this type of video is only produced if a user clicks to request a video.

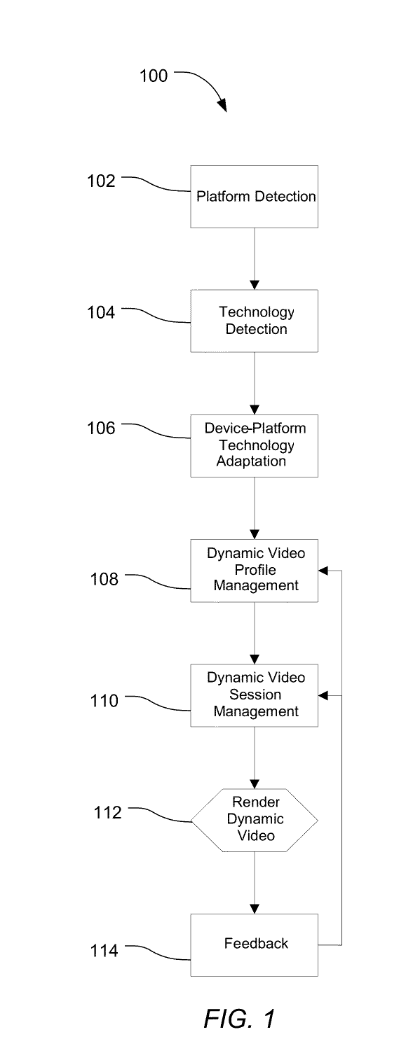

Turning now to FIG. 1, a flow diagram is shown illustrating a video generation process 100 according to an embodiment. As an overview, the example process 100 provides dynamic data-driven video presentations through a combination of technologies and/or steps, including platform detection 102, technology detection 104, platform/technology adaptation 106, dynamic video profile management 108, dynamic video session management 110, dynamic video rendering 112, and feedback 114 through dynamic video data logging and reporting. In some cases each step/element in the process can be considered part of an “input-decision” process that creates a greater layer of customization to deliver dynamic video presentations that are tailored to the user's device and preferences.

In this example, platform detection 102 and technology detection 104 are interrelated with platform and technology adaptation 106 in that platform/technology detection are both input processes (e.g., information gathering), while platform/technology adaptation is a decision or action-taking process based on the information gathered in the platform and technology detection processes. Other processes in the video generation process 100 are combined “input-decision” processes. In some cases profile management 108 is related to session management 110 in that profile management 108 occurs after a previous session. The feedback process 114 provides reporting and logging of the events occurring during the process 100.

Continuing with reference to FIG. 1, in some cases a portion of a video production system (e.g., part or all of a video production platform such as Liquidus DVP-4) employs the platform detection process 102 to detect information about the user device (i.e., platform) that is calling a video presentation. For example, the system may receive and determine various information about the user device (e.g., type of device, browser type, etc.) from an HTTP request generated when a user clicks on a video hyperlink with the user device. This information can then be used to render video on the particular user device. Just some examples of possible user devices include an iPhone using Safari®, a desktop PC using Internet Explorer® 8, a Macintosh laptop using Firefox®, a tablet using Safari, an Android phone using WebKit2, and an iTV device such as Apple TV, or an iTV-enabled cable box, like a Motorola 7350 set-top box with iTV-enabling software. Of course other types of parameters or information about the user device may be detected or determined at this stage, and embodiments of the invention are not limited to any particular type of parameter.

In some cases the video generation process 100 also employs the technology detection process 104 to detect technological components or hardware specifications of a user device, such as its processing speed, its bandwidth/connection speed, its screen size, etc. In some embodiments, a video production system may infer such technological parameters based on the parameters detected with the platform detection process 102. For example, the system may have access to, or locally store, a database of technical configurations for multiple user devices, including compatible operating systems, browsers, and other software. Upon determining that a user device is running particular software, the system can look up compatible user devices and thus gain knowledge about possible hardware or other technical specifications for the particular user device requesting the video presentation. As just one example, upon determining that a user device is running the iOS operating system with a Safari browser, the system can infer that the user device is a mobile device made by Apple, such as an iPhone or iPad. The system may further determine (e.g., via specification tables) that the user device likely has a relatively small screen size and a relatively slow Internet connection (e.g., 3G).

Returning to FIG. 1, embodiments employing the video generation process 100 may adapt 106 aspects of the video generation process and/or the resulting video presentation and/or video player based on the information determined using the platform detection process 102 and/or the technology detection process 104. Embodiments employing platform/technology adaptation 106 may make any of a variety of adaptations, including changing, optimizing, or otherwise modifying the video generation process, the resulting video presentation, the video player, playback parameters and/or other parameters related to the video presentation. In some cases, the information provided in the platform detection 102 and/or technology detection 104 processes can be used to generate a video presentation that may be more suitable for a user device because the video has been modified or video player has been chosen based on the determined information about the device. In some cases platform/technology adaptation 106 may allow generation of video presentations that are compatible with different user devices. In some embodiments the adaptation process 106 may optimize the video presentation for a type of user device.

In some cases, the platform/technology adaptation process 106 can enable selection of a compatible rendering method/format for displaying video on a given device/platform. One example in the mobile communications space relates to the iOS platform used by Apple. Apple's iOS does not support the Adobe “Flash” format for displaying video on its mobile devices (such as iPhones and iPads). One method of addressing this is creating and distributing hard file formats that will play on iOS devices (e.g., .mp4 or .4MV). According to some embodiments, a video production system can generate a video player and/or video presentation based on HTML5 to enable playback of dynamic video presentations on these types of devices. HTML5 is just one example of a rendering method. Embodiments are not limited to any particular type of video rendering or format, and may incorporate presently known methods and formats or those yet to be developed.

In some embodiments the device platform/technology adaptation process 106 can also or instead be used to deliver a customized dynamic video presentation. For example, video features and aspects that may be modified can include, but are not limited to a) the size and shape in which to render the video player, b) the number of video assets (e.g., images) to include in the presentation, c) the number or type of graphic overlays to include, d) the quantity and point size of the text in the display, e) the size (e.g., length) of audio segments or overall audio, and, f) the overall size (e.g., length or file storage size) of the video presentation.

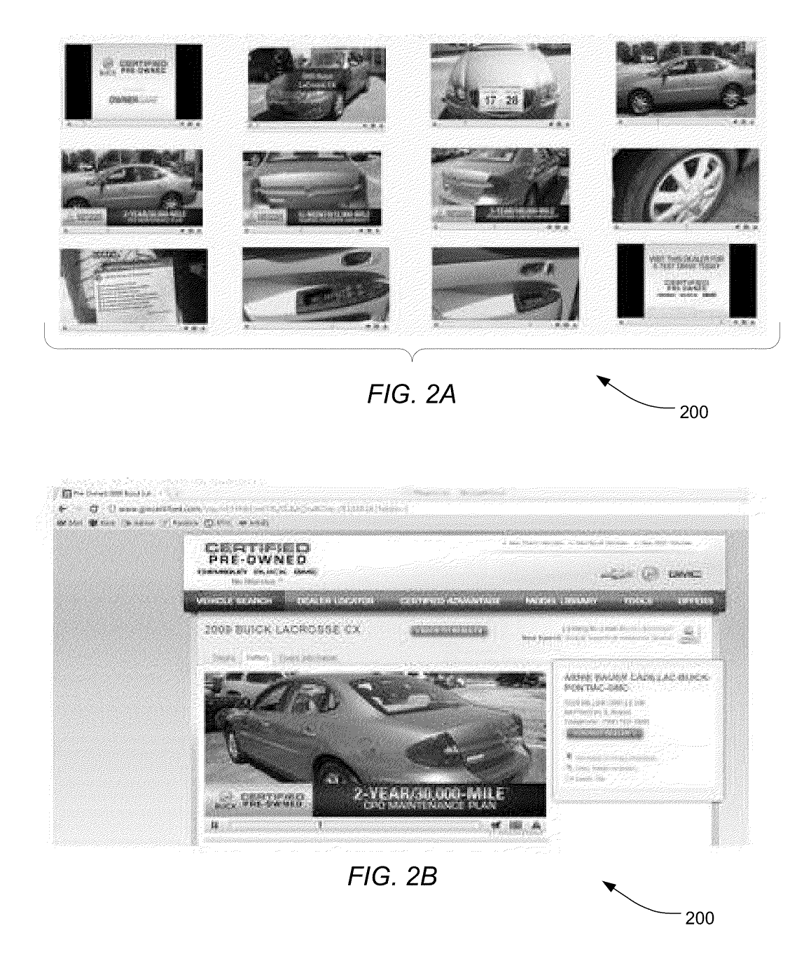

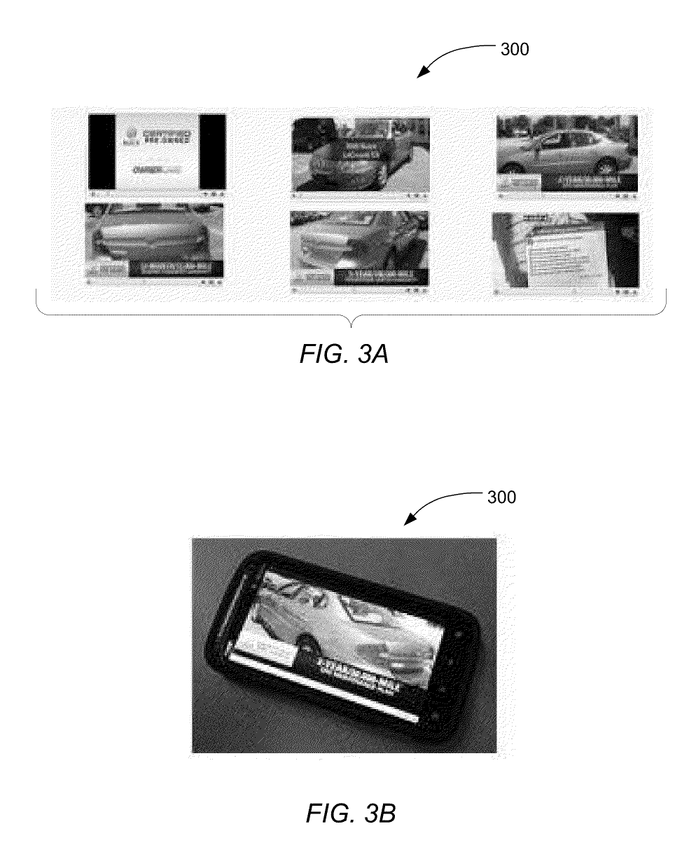

FIGS. 2A, 2B, 3A, and 3B illustrate two different video presentations that could be generated for different user devices according to some examples. FIG. 2A illustrates an example of screenshots that could be generated for a desktop computer. In this example the platform detection 102 and technology detection 104 processes may determine that the user device requesting a video presentation is a desktop PC operating Microsoft Windows XP, Internet Explorer, and Adobe Flash, and that the PC has a large screen (e.g., 1400×1050 pixels, 20″) and a relatively fast Internet connection (e.g., a broadband connection such as DSL, cable Internet, fiber optic cable, etc.). One or more portions of a video production system may employ the platform/technology adaptation process 106 to generate a video presentation 200 that includes a wide, rectangular Flash player with menu items that display outside of the video frame, and could include 10 images playing for :05 seconds each, a :07 pre-roll video, a post-roll video, unlimited graphic overlays, and a full-length audio track. FIG. 2B illustrates an example of what such a video presentation 200 could look like using a desktop PC as a user device.

FIG. 3A illustrates a collection of screenshots that could be generated for a video presentation on a smartphone. In this example the platform detection 12 and technology detection 14 processes may determine that the user device requesting a video presentation is a smartphone such as an iPhone 4 operating Apple's iOS operating system with a Safari browser and that the iPhone has a small screen (e.g., 960×640 pixels, 3.5″) and a slower Internet connection (e.g., 3G). One or more portions of a video production system may employ the platform/technology adaptation process 16 to generate a video presentation 300 in a relatively narrow, rectangular HTML5 player with menu items within the screen, and may choose to include only 5 image assets playing :03 each, a :03 pre-roll, 2 graphic overlays, and only limited text and audio segments. FIG. 3B illustrates an example of what such a video presentation 300 could look like using a smartphone such as an iPhone as a user device.

Returning to FIG. 1, in some embodiments, the video generation process 100 makes use of the profile management process 108 and/or the session management process 110, though it should be understood that either or both of these processes may not be used in some embodiments. As mentioned above, in some examples, profile management 108 is related to session management 110 in that the profile management may only occur after a previous session has occurred. For example, a first-time visitor to a site enabled according to one embodiment could have the benefit of customization based on the actions that visitor is taking within the session he or she is in, but because the visitor has not come to the site previously, there will be no pre-existing profile on which to customize their experience on the first visit.

In some cases the dynamic video profile management process 108 is a method of further customizing video presentations based on a user's previous behavior across one or more sessions. For example, in some cases a session may be considered a “site video visit” in which the user opens and interacts with one or more videos on a single website. A content customization process can be applied based on what a user is doing during a session as discussed further below, or based on what a user has done previously across multiple sessions. The latter is an example of profile management.

In some embodiments portions of a video production system may use web cookies to customize and deliver dynamic video content. Some examples of the activities that can be monitored by a content provider as a user interacts with a dynamic video presentation include the user's activity with player buttons (e.g. play, fast forward, pause, rewind, replay), the user's activity within the player menu (e.g. send to a friend, view map, contact advertiser, view thumbnails), the user's link-clicking activity within video content, and the fundamental statistical information about a user's activity, such as number of plays, percentage of a video viewed, and the vehicle that was viewed (e.g., make, model, unit). A user may return to a site on several occasions (e.g., several sessions), and thus a profile of that user may be generated across sessions.

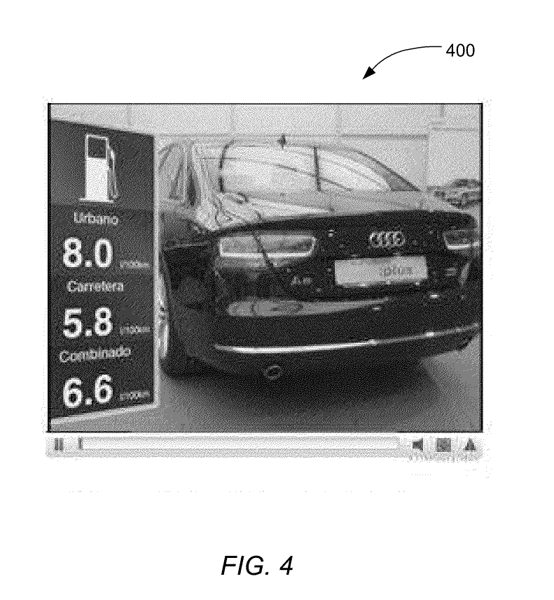

Having in some cases gathered preference information fed back about the user during previous sessions, part of the video production system may optionally customize a current video presentation based on factors including the user's previous indications of product preferences, language preferences, or offer and feature preferences. One example of using the profile management process 108 relates to an automobile-shopping context. In this case the user may have shopped SUVs in one session, indicated a preference for information in Spanish during another session, and explored financing options during yet another. Profile management 108 may then be used to render and display the video based on that user's previous preference indications, which may include Spanish text, detailed information on financing, and cross-selling information regarding certain SUV models, for example. FIG. 4 is a depiction of a video presentation 400 including Spanish language text, which could be generated based on user activities in previous session indicating a preference for the Spanish language.

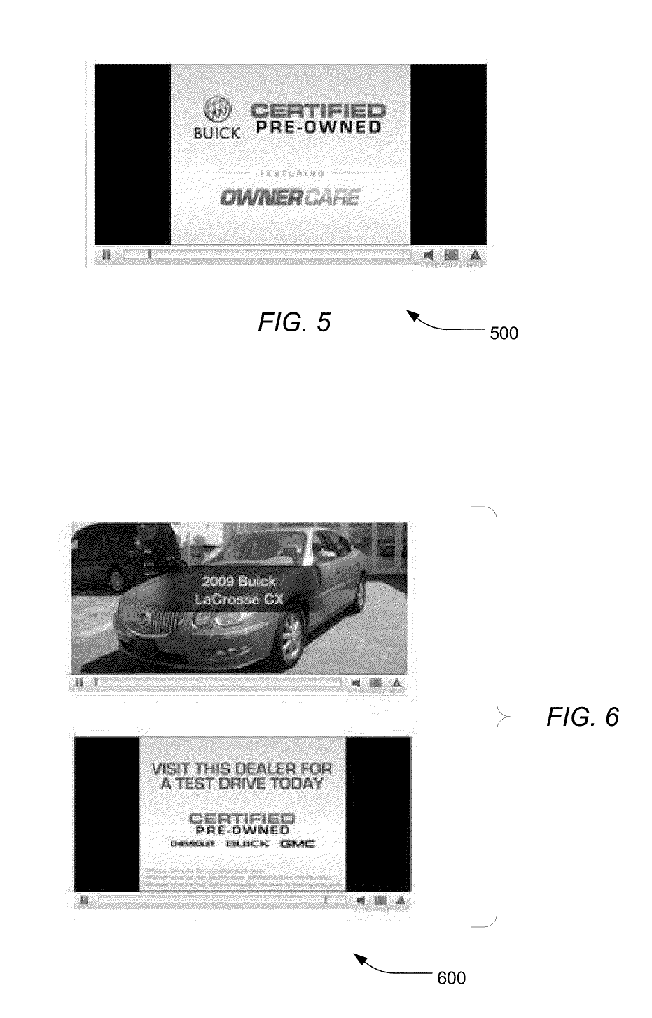

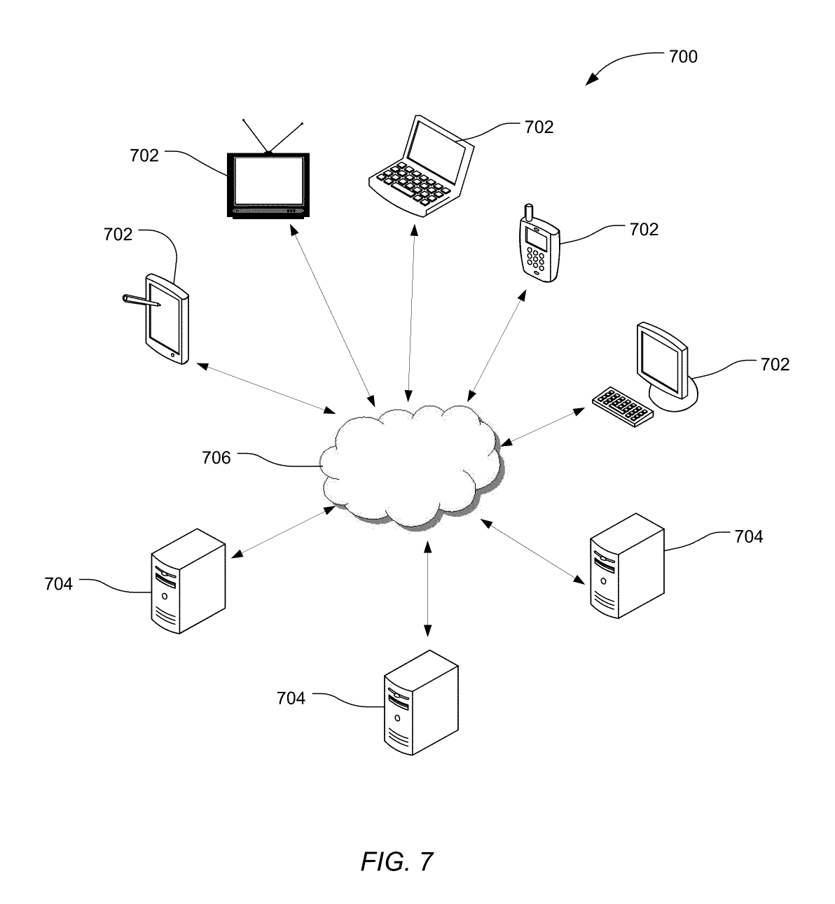

In some embodiments, video presentations may be customized based on what a user is doing during a session using the session management process 110. In some cases, session management can allow customization of video presentations based on current activities when a record of previous activities and profile management are not available. One example relating to the automotive context may include a user viewing several video presentations on an auto dealer's website during a session. In some cases each video would start with a promotional “pre-roll video” about the dealer, but the session management process 110 can be used to decide, after several video views, to shorten, eliminate or move the pre-roll to a post-roll position because the user has already seen it in a previous video view. FIG. 5 is a depiction of a video presentation 500 including information about an automotive certified/pre-owned program included in a pre-roll, while FIG. 6 is a depiction of a video presentation 600 including information about the automotive certified/pre-owned program in a post-roll position. Accordingly, in this example, session management 110 can limit or eliminate the delivery of redundant promotional content that could potentially irritate the user and delay his or her ability to view the specific product video content the user is interested in seeing.

As shown in FIG. 1, in some embodiments the rendering process 112 part of the video generation process 100 concludes the modification and/or customization of a particular video presentation, which is rendered and then displayed by the requesting user device. During playback on the user device, and otherwise during a user session, information about the user's activities can be logged and reported back to a portion of the system (e.g., with browser cookies) as part of a feedback process 114. In some cases the feedback process 114 can be used to further modify and/or customize subsequent video presentations. For example, the feedback process 114 may involve transmitting preference information that can be used to customize subsequent video presentations within the profile management process 108 and/or the session management process 110.

In describing various embodiments in this description, many aspects of the embodiments are discussed in terms of functionality, in order to more particularly emphasize their implementation independence. Certain functionality may be implemented within one or more parts (e.g., devices) of a video production system using a combination of hardware, firmware, and/or software. Some embodiments include devices with processing circuitry configured to provide the desired functionality. For example, in some embodiments processing circuitry can include a programmable processor and one or more memory modules. Instructions can be stored in the memory module(s) for programming the processor to perform one or more tasks. Some types of programmable processors include microcontrollers, microprocessors, and central processing units. Some types of computer-readable storage media that can be used to provide the memory modules include any of a wide variety of forms of non-transitory (i.e., physical material) storage mediums, such as magnetic tape, magnetic disks, CDs, DVDs, solid state memory (e.g., RAM and/or ROM), and the like.

In certain embodiments, processing circuitry can include a computer processor that contains instructions to perform one or more tasks, such as in cases where a field programmable gate array (FPGA) or application specific integrated circuit (ASIC) are used. The processing circuitry (e.g., processor) is not limited to any specific configuration. Those skilled in the art will appreciate that the teachings provided herein may be implemented in a number of different manners with, e.g., hardware, firmware, and/or software.

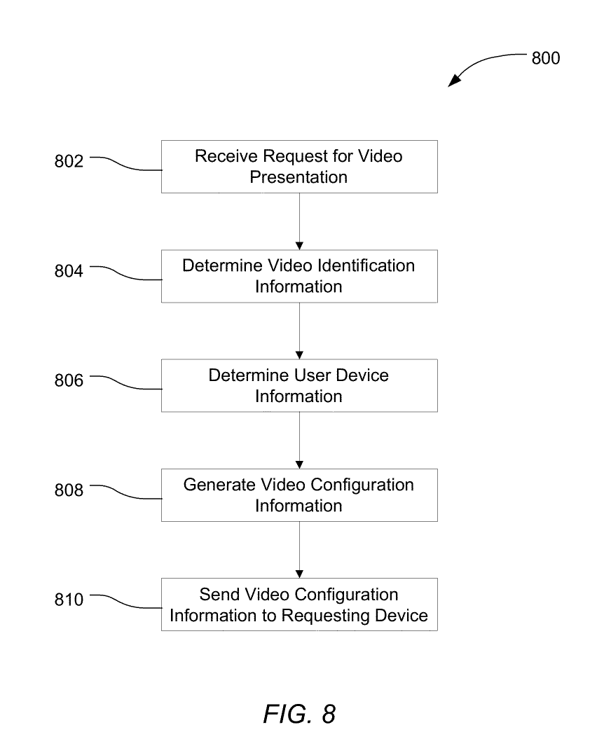

FIG. 7 is a schematic diagram illustrating a video production system 700 including a number of computing devices that include processing circuitry that may be configured to provide some or all of the functionality described herein with respect to certain embodiments. According to the embodiment shown in FIG. 7, the production system 700 includes user devices 702 and a number of server computers 704 in communication through a computer network 706. As illustrated, user devices 702 may take the form of a variety of different types of devices depending upon the particular implementation. In some cases one or more desktop computers and/or mobile computers may be user devices 702. According to some embodiments, a user device 702 can be any suitable type of mobile computer including processing circuitry and a display that can connect to the computer network 706. Examples include, but are not limited to laptop computers, smartphones, tablet computers, netbooks, mobile telephones, and web-enabled (e.g., iTV-enabled) televisions and cable boxes. According to some embodiments, each server computer 704 can be provided by any type of suitable computing device with sufficient processing capabilities.

According to some embodiments, the computer network 706 may be any type of electronic communication system connecting two or more computing devices. Some examples of possible types of computer networks include, but are not limited to the Internet, various intranets, Local Area Networks (LAN), Wide Area Networks (WAN) or an interconnected combination of these network types. Connections within the network 706 and to or from the computing devices connected to the network may be wired and/or wireless. In some embodiments, video production system 700 can include a plurality of user devices 702 and computer servers 704 that communicate according to a client-server model over a portion of the world-wide public Internet using the transmission control protocol/internet protocol (TCP/IP) specification. In this case, one or more computer servers 704 may host certain portions of the video production system that a client such as a web browser may access through the network 706. Using this relationship, a client user device (the “client”) issues one or more commands to a server computer (the “server”). The server fulfills client commands by accessing available network resources and returning information to the client pursuant to client commands.

It should be appreciated that FIG. 7 illustrates just one example of a possible video production system. In some cases a video production system may include a large number of computing devices and in some cases a system may include a few, or conceivably, only one computing device. In addition, the terms “user device” and “server computer” are used for convenience to refer to different computing devices connected to the computer network 706 according to some embodiments, but are not intended to limit the type of hardware, software, and/or firmware that may be used to provide any particular computing device. For example, in some cases similar or identical computing devices may provide both the user devices and server computers. Further, portions of the video production system's functionality may be provided by multiple computing devices across the network 706, including user devices 702, computer servers 704, and/or other types of computing devices.

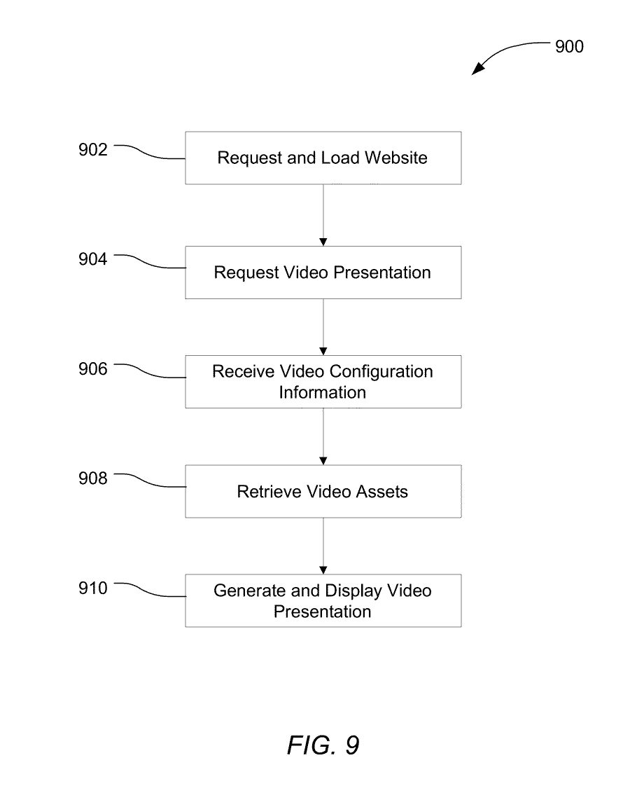

According to some embodiments, different portions of the processing circuitry within a video production system may be configured to provide certain portions of the processing and/or functionality of the video production system. For example, different portions of the processing circuitry may be configured to implement certain portions of the video generation process 100 illustrated in FIG. 1. FIG. 8 is a flow diagram illustrating one example of a method 800 of generating video configuration information that can be part of a method of generating a data-driven, dynamic video presentation according to some embodiments. A portion of the processing circuitry in a video production system (e.g., a server computer) can be configured to implement the method 800.

Referring to FIG. 8, the method 800 begins with the processing circuitry receiving 802 a request from a user device to generate a data-driven, dynamic video presentation. The processing circuitry is in communication with the user device and receives the request through a computer network, such as the network 706 shown in FIG. 7. According to some embodiments, the request includes certain types of information that the processing circuitry can use when generating the video configuration information. For example, the request generally includes video identification information that points to or otherwise identifies the particular video presentation being requested by the user device. As another example, the request can also include one or more types of user device information that describe or characterize the user device requesting the video presentation.

One example of a request from a user device may be generated when the operator of the user device selects a hyperlink on a webpage that is associated with the desired video presentation. In this example, upon selecting the hyperlink an http request associated with the video presentation is sent to the portion of the processing circuitry executing the method 800 of generating video configuration information shown in FIG. 8. In some cases the http request includes header information that includes the user device information and the video identification information. As just an example, the http header information may identify the referring link, which is associated with the desired video presentation. The http header information may also identify the user agent, which includes user device information that describes some of the characteristics of the software and/or hardware of the user device. Table 1 illustrates an example of referring information and user agent information.

TABLE 1
An example of information included in a request from a user device.

| | | |
|---|---|---|
| Video Identification | REFERRER | HTTP://WWW.VIDEOSWEBPAGE/VIDEO1/ |
| Information | | |
| User Device | USER-AGENT | MOZILLA/5.0 (IPHONE; U; CPU IPHONE OS 4_2_1 |
| Information | | LIKE MAC OS X; EN-US) APPLEWEBKIT/533.17.9 |
| | | (KHTML, LIKE GECKO) VERSION/5.0.2 |
| | | MOBILE/8C148 SAFARI/6533.18.5 |

Of course, this is just one possible example of different types and possible formats of user device information and video identification information and all embodiments are not limited to this example only. In some cases video identification information can be any type of data included with a video request that generally or specifically identifies a desired video presentation. In general, the user device information can be any type of data included with the video request that describes some aspect of the user device to the receiving processing circuitry. Some examples of user device information include, but are not limited to, types and/or versions of software running on the user device (e.g., operating system, web browser, browser plug-ins, media players, etc.). In some cases the user device information may describe hardware aspects of the user device, or may indirectly provide information about the hardware of the user device as will be described further herein.

Returning to FIG. 8, upon receiving 802 the request for a video presentation from a user device, the processing circuitry then determines 804 the video identification information and determines 806 the user device information. In some cases determining 806 the user device information is part of the platform detection 102 and/or technology detection 104 processes illustrated in FIG. 1. Returning to FIG. 8, the processing circuitry may determine the product/device information by reading, analyzing, parsing, or otherwise processing the request received from the user device. After determination, the processing circuitry may store the determined video identification information and determined user device information, e.g., in a computer-readable storage medium, for later recall.

According to some embodiments, the processing circuitry executing the method 800 may optionally determine additional information about the user device based on the user device information extracted from the video request. As just an example, the processing circuitry may inferentially determine a hardware specification (e.g., processing speed, display size, network connection speed, manufacturer, date of manufacture, etc.) based on the user device information included in the video request. In some cases this indirect determination may be part of the technology detection process 104 shown in FIG. 1. For example, the processing circuitry may infer such technological parameters based on user device information directly identifying a type of software running on the user device. In some cases processing circuitry may include or have access to a database of technical configurations for multiple user devices, including compatible operating systems, browsers, and other software. Upon determining that a user device is running particular software, the processing circuitry can look up compatible user devices and thus gain knowledge about possible hardware or other technical specifications for the particular user device requesting the video presentation.

Returning to FIG. 8, the method 800 also includes generating 808 video configuration information that can be sent 810 to the user device, thus enabling the requesting user device to generate and display the video presentation. Prior to and/or as part of the generating 808 of the video configuration information, the processing circuitry may determine one or more aspects of the video configuration information and resulting video presentation based on the determined user device information and/or the determined video identification information. For example, the processing circuitry may determine such information as part of the device-platform technology adaptation process 106 shown in FIG. 1.

According to some embodiments, a data-driven dynamic video presentation includes a number of video assets combined into a single video presentation. The video assets may be any desirable type and format of information that may be included in a video presentation. In some cases, the video assets can include one or more images, audio segments, video segments, and/or text statements. As part of the platform/technology adaptation and/or the generation of video configuration information, the processing circuitry may determine the number and/or type of video assets to include in a video presentation based on the determined user device information and one or more predetermined criteria or rules.

For example, in some cases, the processing circuitry may determine a number of video assets to include in the video presentation based on the user device information. In some cases this may involve determining a threshold number of video assets, such as a maximum and/or minimum number of images to include in the video presentation. In some cases, for example, the processing circuitry may determine from the video identification information that the requesting user device is a smartphone with a relatively small screen with a wireless internet connection. Based on that information, the processing circuitry may determine that the video presentation should only include a maximum number of video assets (e.g., images) to limit download time and that the video assets should be reformatted to fit on the smaller screen. As another example, the processing circuitry may determine a size, such as a length or a file storage size, of an audio and/or video segment based on the user device information. In some cases the processing circuitry may determine, for example, a maximum size for an audio and/or video segment to accommodate certain user device parameters such as a slow network connection. Another example includes determining a number of graphic overlays to include in a video presentation based on the user device information and one or more predetermined criteria.

According to some embodiments, the processing circuitry may optionally determine a preferred type of media player for displaying a video presentation with the user device. For example, upon determining 806 the user device information, the method 800 may optionally include selecting a video player type from among a number of types based on the user device information and one or more criteria. As just one example, in some cases processing circuitry may determine that the requesting user device is using an Android-based operating system that supports Adobe Flash media. The method 800 may then include selecting Adobe Flash as the preferred type of video player. In another example, processing circuitry may determine that the requesting user device is using an Apple-based operating system that does not support Adobe Flash media but does support HTML5 video presentation. The method 800 may then include selecting an HTML5 video player as the preferred type of video player.

In some embodiments, the processing circuitry may be configured to optionally determine user information about an operator of the requesting user device. For example, upon receiving 802 the request for the video presentation, the processing circuitry may optionally determine whether any user information is included with the request. Such user information can include, for example, demographic information about the user, information about one or more actions of the user, information about past experiences with the user, language preferences, and/or any other desirable information that can be transmitted from the user device to the processing circuitry carrying out the method 800. The user information may in some cases be sent using browser cookies as described above.

According to some embodiments, the processing circuitry may determine the occurrence of user actions within specific periods of time. For example, in some cases the processing circuitry may receive user feedback (e.g., user information) from the user device during a session period and determine a corresponding user action. In some cases the processing circuitry may receive user feedback during a first session period, determine the corresponding user action, and then generate video configuration information during a second session period based on the user action from the first session period. In some cases such techniques can be used to implement session and/or profile management of video presentation preferences as described above.

Of course these are just a few examples of possible ways that processing circuitry may adapt the content or presentation of a desired video presentation based on determining certain information and variables from the user device information. Embodiments do not require and are not limited to any particular combination of adaptations and those skilled in the art will appreciate that a wide variety of adaptations are possible in various embodiments.

Returning to FIG. 8, after determining 804 the video identification information and determining 806 the user device information in the request from the user device, and making any other (e.g., optional) determinations based on the user device information, the video identification information, and/or optional user information, the method 800 includes generating 808 video configuration information using, among other things, one or more of the previous determinations.

According to some embodiments, video configuration information can be adapted, customized, or otherwise modified based on previous determinations in order to tailor a requested video presentation for a requesting user device and/or user. In some cases, video configuration information is a collection or listing of data, parameters, and/or other information that is sent to the requesting user device to enable it to generate and display a particular data-driven video presentation. In some cases, the user configuration information may include one or more instructions that direct or instruct the user device (e.g., software applications running on the user device) to assemble, render, and/or display a video presentation in a particular manner. In some cases the user configuration information may include addresses or otherwise indicate the location of one or more video assets or other information that the user device can then retrieve to generate the video presentation. For example, the video configuration information may include location pointers (e.g., URLs) that direct the requesting user device to retrieve certain video assets and other information from a computer-readable storage medium associated with the location pointer.

Examples of information and/or instructions that may be included upon generating the video configuration information include, but are not limited to, instructions/information for the user device to: display a video presentation with a particular type of video player (e.g., with a Flash player, with an HTML5 player, or with some other type of media player); display a video presentation in a certain size and/or aspect ratio; retrieve and display a certain number of video assets, retrieve and display a certain number images in a scripted order; retrieve and display a maximum number of video assets; retrieve and display one or more video segments of a predetermined size; retrieve and play one or more audio segments of a predetermined size in various orders; generate text statements to include with the video presentation; generate and overlay certain graphics within the video presentation, e.g., overlaying certain images; position certain segments of the video presentation at one of a number of times during the video presentation; display text with a certain language; and make changes to the video presentation based on user information, including information about past user actions.

Of course these are just a few examples of possible instructions that may be included in generated video configuration information. Embodiments do not require and are not limited to any particular combination of instructions and those skilled in the art will appreciate that the inclusion of a wide variety of instructions and other information pertinent to the configuration of a video presentation are possible in various embodiments.

The processing circuitry may generate the video configuration information in any suitable manner, which may vary depending upon the format necessary to send the video configuration information to the user device. In some cases the processing circuitry may include statements within a video configuration file that can be interpreted by the user device (e.g., a software program on the user device). In some cases, the processing circuitry implementing the method 800 may generate a script containing the video configuration information that can be sent to the user device and executed by one or more programs operating on the user device. As just one example, in some cases generating 808 video configuration information includes generating and sending a script (e.g., writing in any suitable scripting or other programming language) to the user device. Upon receipt, a web browser running on the user device may execute the script, which causes the web browser to embed a particular type of video player (e.g., Flash, HTML5, etc.), retrieve certain video assets from locations specified in the script, assemble the video assets as a video presentation, and display the video presentation using the embedded video player.

It should be realized that generating and sending a script is just one possible example of generating 808 and sending 810 video configuration information to a user device. Embodiments are not limited to any particular manner of generating video configuration information, and may incorporate presently known methods and practices or those yet to be developed.

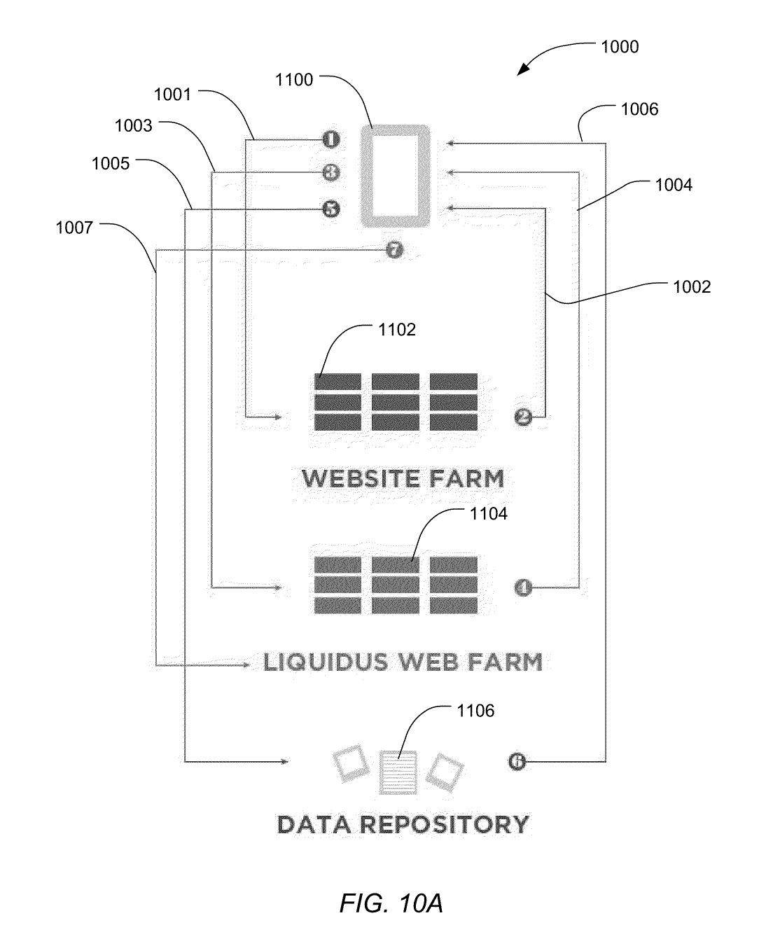

FIG. 9 is a flow diagram illustrating one example of a method 900 of requesting and generating a data-driven video presentation that can be part of a more complex method of generating a data-driven, dynamic video presentation according to some embodiments. A portion of the processing circuitry in a video production system (e.g., a user device) can be configured to implement the method 900. In the illustrated example, the portion of the processing circuitry executing the method 900 may be a part of any computing device that is part of the video production system. For simplicity, the following discussion presumes that the portion of the processing circuitry is part of a user device.

Returning to FIG. 9, the user device sends a request for a website or webpage, receives the website data, and then loads the website data for display as the corresponding webpage 902. For example, a user may navigate to a website on the Internet with a web browser application on the user device. In some cases the website may be provided by a vendor (e.g., a web hosting company, distributor, supplier, seller or other entity) of certain products and/or services. In this case, the request is for vendor information (e.g., the vendor's website data), which is then sent to and received by the user device and used to render a webpage in the user device's web browser. In some embodiments, the vendor's webpage includes one or more hyperlinks (i.e., pointers) that point to one or more corresponding video presentations that a user may wish to view.

According to some embodiments, a separate portion of the video production system (e.g., a portion of processing circuitry within a separate server computer) may receive the request for vendor information and send the vendor information to the user device. As just one example, a portion of the processing circuitry that handles requests for vendor data may be a part of a third-party web server. Of course this is just one example and if a portion of processing circuitry handles vendor information, it is not required to be associated with any particular computing device.

To view a video presentation, a user may select a particular hyperlink, which causes the user device to send a request 904 to generate a video presentation to another portion of a video production system. In some cases the video request may be sent to the same portion of the production system that hosts the vendor webpage. In some cases, the video request may be sent to another portion of a video production system. For example, a third-party application server may include processing circuitry that responds to requests for video presentations directed from a web page hosted on a web server computer. The video presentation may be a data-driven, dynamic presentation that is assembled from one or more video assets stored in a computer readable storage medium in the same or another portion of the video production system.

In some cases, the portion of the video production system that receives the request to generate a video presentation generates video configuration information at least partially based on the request and sends the video configuration information back to the user device, enabling the user device to generate the video presentation. As just one example, the method 800 illustrated in FIG. 8 may be used by a portion of the video production system to generate video configuration information.

Returning to FIG. 9, the user device receives 906 the video configuration information and then uses the video configuration information to generate and display 910 the video presentation. Prior to generating the video presentation, the user device uses the video configuration information to retrieve 908 video assets and other information and then assemble the various parts into the video presentation which is displayed 910 by the user device on its electronic display. As described elsewhere herein, in one example the video configuration information may be part of a script that is executed by a web browser on the user device. Following the script, the web browser retrieves various images and other video assets from specified locations, assembles the parts, embeds a selected type of media player, and then renders the video presentation using the selected media player on the display of the user device.

Of course, this is just one example of a possible implementation of generating and displaying a video presentation as provided in FIG. 9. Embodiments are not limited to any particular manner of generating and displaying a video presentation, and may incorporate presently known methods and practices or those yet to be developed.

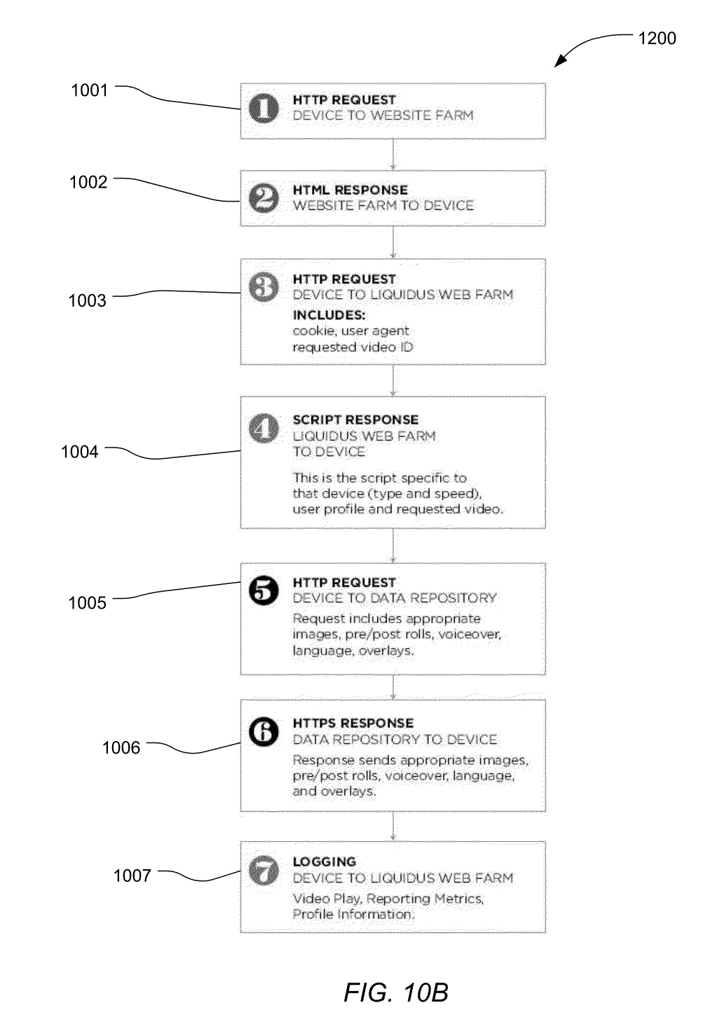

FIG. 10A is a schematic system diagram illustrating data flow between components of a video production system 1000 according to some embodiments. FIG. 10B is a corresponding flow diagram illustrating a method 1200 of generating a video presentation using the system illustrated in FIG. 10A according to some embodiments. Turning to FIG. 10A, the video production system 1000 in this example includes a user device 1100, a website farm 1102, a video production platform (e.g., Liquidus) web farm 1104, and a data repository 1106 in communication through a network (not shown in FIG. 10A).

According to some embodiments, each of the user device 1100, website farm 1102, video production platform web farm 1104, and data repository 1106 are provided by computing devices that include a portion of the processing circuitry that enables operation and use of the video production system 1000. As just an example, a first server computer can include processing circuitry that is configured to provide the functionality associated with the video production platform 1104, a second server computer can include processing circuitry that is configured to provide the functionality associated with the website farm 1102, a third server computer can include processing circuitry that includes one or more computer readable storage mediums for storing video assets and other information needed by the system 1000, and a desktop or mobile computing device (e.g., a smartphone) can include processing circuitry that is configured to provide the functionality associated with the user device 1100. Of course this is just one example and other system configurations with more or less computing devices may be used in some embodiments.

FIG. 10B illustrates some steps in a method of generating a video presentation that can be implemented by the system 1000 shown in FIG. 10A. Corresponding steps are identically numbered in each of FIG. 10A and FIG. 10B. According to some embodiments, generation of a data-driven video presentation is initiated within the video production system 1000 with an HTTP request 1001 from the user device 1100 to the website farm 1102. For example, a user may click on a hyperlink or enter the address of the a page hosted by the website farm 1102. The website farm 1102 responds with an HTML response 1002 that is sent back to the user device 1100, and may include vendor information that the user device 1100 can display as a webpage. Using the vendor information within the HTML response 1002, the user device 1100 generates an HTTP request 1003 that is sent to the video production platform (e.g., Liquidus DVP-4) 1104. In some cases the HTTP request 1003 includes user information associated with a cookie, user device information describing the user agent, and video identification information indicated the requested video presentation. As a next step in the method 1200, the video production platform (e.g., a portion of processing circuitry) analyzes the HTML request 1003 and other information sent by the user device 1100 and uses the information to generate video configuration information in the form of a script response 1004. As illustrated in FIG. 10B, the script response 1004 may in some cases be generated specifically for a particular device (e.g., by type, speed), a specific user profile, and the requested video presentation. After receiving the script response 1004, the user device 1100 then executes the instructions in the script/configuration information and sends an HTTP request 1005 to the data repository 1106 to retrieve the video assets and other information (e.g., images, pre/post rolls, voiceover, language, overlays, and other information). The data repository 1106 responds with an HTTPS response 1006 to the user device 1100, delivering the requested video assets and other information. In some cases, the method 1200 also includes a logging transmission 1007, in which the user device 1100 sends data back to the video production platform 1104 to enable further customization of subsequent video presentations.

Of course it should be appreciated that the illustrated embodiment depicted in FIGS. 10A and 10B is just one example and that some embodiments of the invention may include additional features and functionality and/or less features and functionality that the depicted embodiment. In addition, while FIGS. 10A and 10B illustrate one particular configuration for a video production system 1000 and method of use 1200, it should be appreciated that some embodiments are directed to subsections or portions of a video production system, as illustrated by other examples herein (e.g., the methods in FIGS. 8 and 9 and the accompanying descriptions).

Thus, some embodiments of the invention are disclosed. Although certain embodiments have been described in detail, the disclosed embodiments are presented for purposes of illustration and not limitation and other embodiments of the invention are possible. One skilled in the art will appreciate that various changes, adaptations, and modifications may be made without departing from the spirit of the invention and the scope of the appended claims.

What is claimed is:

1. A method comprising:
receiving, with processing circuitry, a request from a user device through a computer network to generate a dynamic data-driven video presentation using one or more video assets, the request comprising video identification information and user device information;
determining, with the processing circuitry, the video identification information from the request;
determining, with the processing circuitry, the user device information from the request;
generating, with the processing circuitry, video configuration information based on the video identification information and the user device information; and
sending, with the processing circuitry, the video configuration information to the user device through the computer network to enable the user device to generate the video presentation based on the video configuration information.

2. The method of claim 1, further comprising determining software running on the user device from the user device information and generating the video configuration information based on the determined software.

3. The method of claim 2, wherein the determined software comprises an operating system of the user device.

4. The method of claim 1, further comprising determining a hardware specification of the user device based on the user device information and generating the video configuration information based on the hardware specification.

5. The method of claim 1, wherein the one or more video assets comprise one or more images, audio segments, video segments, and/or text statements.

6. The method of claim 5, further comprising determining a number of images based on the user device information and generating the video configuration information based on the determined number of images.

7. The method of claim 5, further comprising determining a size of an audio segment and/or a size of a video segment based on the user device information, and generating the video configuration information based on the determined size of the audio segment and/or the determined size of the video segment.

8. The method of claim 1, wherein the video configuration information comprises one or more instructions that instruct the user device to generate the video presentation.

9. The method of claim 8, further comprising selecting a video player type from among a plurality of video players types based on the user device information and wherein the one or more instructions indicate the selected video player type for the user device to use for displaying the video presentation.

10. The method of claim 8, wherein the one or more instructions comprise one or more location pointers the user device can use to retrieve the one or more video assets.

11. The method of claim 8, wherein the video configuration information comprises a script.

12. The method of claim 1, further comprising receiving feedback from the user device during a session period, determining a user action occurring during the session period, and generating the video configuration information based on the determined user action.

13. The method of claim 12, further comprising receiving feedback from the user device during at least a first session period, determining a user action occurring during the first session period, and generating the video configuration information during a second session period based on the determined user action.

14. A system comprising processing circuitry, the processing circuitry configured to:
receive a request from a user device through a computer network to generate a dynamic data-driven video presentation using one or more video assets, the request comprising video identification information and user device information describing the user device;
determine the video identification information from the request;
determine the user device information from the request;
generate video configuration information based on the video identification information and the user device information; and
send the video configuration information to the user device through the computer network to enable the user device to generate the video presentation based on the video configuration information.

15. The system of claim 14, further comprising at least one computer readable storage medium storing at least one of the one or more video assets.

16. The system of claim 15, wherein the processing circuitry is further configured to receive a request from the user device for vendor information and send the vendor information to the user device, the vendor information comprising a video presentation pointer that the user device can use to send the request for the video presentation.

17. The system of claim 16, further comprising:
a first server computer comprising at least a first portion of the processing circuitry, the first portion of the processing circuitry configured to receive the request for the video presentation from the user device, determine the video identification information, determine the user device information, generate the video configuration information, and send the video configuration information to the user device through the computer network;
a second server computer comprising at least a second portion of the processing circuitry, the second portion of the processing circuitry configured to receive the request from the user device for vendor information and send the vendor information to the user device; and
a third server computer comprising the at least one computer readable storage medium.

18. The system of claim 14, wherein the user device comprises a desktop computer or a mobile computer, the mobile computer selected from the group consisting of laptop computers, smartphones, tablet computers, netbooks, and mobile telephones.

19. The system of claim 14, wherein the video configuration information comprises one or more instructions that instruct the user device to generate the video presentation.

20. The system of claim 19, wherein the processing circuitry is further configured to select a video player type from among a plurality of video players types based on the user device information and wherein the one or more instructions indicate the selected video player type for the user device to use for displaying the video presentation.

21. The system of claim 19, wherein the one or more instructions comprise one or more location pointers the user device can use to retrieve the one or more video assets.

22. A method comprising:
sending, with a user device comprising processing circuitry and an electronic display, a request through a computer network to generate a dynamic data-driven video presentation using one or more video assets stored in a computer readable storage medium separate from the user device, the request comprising video identification information and user device information describing the user device;
receiving, with the user device, video configuration information generated based on the video identification information and the user device information;
receiving, with the user device, the one or more video assets;
generating, with the user device, the video presentation based on the video configuration information, the video presentation comprising the one or more video assets; and
displaying the video presentation on the electronic display of the user device.
